(19) United States
(12) Patent Application Publication
(10) Pub. No.: US 2023/0033292 A1
(43) Pub. Date: Feb. 2, 2023

(54) POWER AND HEAT GENERATOR SYSTEM AND RELATED METHODS

(71) Applicant: Thermal Intelligence Inc., Grande Prairie, Alberta, CA (US)

(72) Inventor: Quinn Bowen, Edmonton, Alberta, CA (US)

(21) Appl. No.: 17/756,154

(22) PCT Filed: Nov. 20, 2020
(86) PCT No.: PCT/CA2020/051588

§ 371 Date: May 18, 2022

Related U.S. Application Data
(60) Provisional application No. 62/939,058, filed on Nov. 22, 2019.

(51) Int. Cl. F24H 3/04; F01P 1/06; F04D 17/10; F24H 3/08; F24H 9/00

(52) U.S. Cl. CPC F24H 3/0417; F01P 1/06; F04D 17/10; F24H 3/087; F24H 9/0063; F24H 2250/02; F24H 2240/06

(57) ABSTRACT

There is provided a generator system for generating power and heat. The system comprises an engine, an electrical power generator driven by the engine, a radiator for cooling engine coolant, a heater powered by the electrical power generator, and an airflow generation device driven by the engine. The heater has an airflow outlet and an airflow inlet. The airflow generation device has an air intake inlet and an air exhaust outlet. The system further comprises a first conduit directing airflow through the radiator into the air intake inlet of the airflow generation device. The system also includes a second conduit directing airflow from the air exhaust outlet of the airflow generation device to the airflow inlet of the heater. The airflow generation device may be a centrifugal fan that draws air through the radiator and pushes the air through the heater.

### CROSS-REFERENCE TO RELATED APPLICATIONS

This application is a national phase entry under 35 U.S.C. § 371 of International Patent Application PCT/CA2020/051588, filed Nov. 20, 2020, designating the United States of America and published as International Patent Publication WO 2021/097580 A1 on May 27, 2021, which claims the benefit under Article 8 of the Patent Cooperation Treaty to United States Patent Application Ser. No. 62/939,058, filed Nov. 22, 2019.

### TECHNICAL FIELD

The present disclosure relates to combination heat and power generator systems. More particularly, the disclosure relates to power and flameless heat generation systems comprising an engine that drives a power generator and a heater powered by the power generator.

### BACKGROUND

Temporary heating systems are used in a variety of industrial applications. As non-limiting examples, such systems may be used to heat work sites, thaw or de-ice equipment used in oil and gas extraction, and/or to heat and dehumidify buildings under construction. A power generator may convert mechanical power created by a combustion engine into electrical power. A conventional combined heat and power generator system may include a combustion engine, an electrical power generator, and a heater. At least a portion of electrical power provided by the power generator may be converted into heat by the heater.

In a conventional combined heat and power generator, a first fan (i.e., radiator fan) driven by the combustion engine may blow air through a radiator for the combustion engine, and at least one second fan may be required to blow air through the heater. The at least one second fan may blow heated air exhaust from the radiator into the heater, where the air is further heated. Such conventional designs, thus, require multiple fans to blow air through the radiator and the heater.

### BRIEF SUMMARY

According to an aspect, there is provided a generator system for generating heat and electrical power, the system comprising: an engine; an electrical power generator driven by the engine; at least one heat exchanger that cools engine coolant; a heater powered by the electrical power generator; an airflow generation device driven by the engine and having an air intake inlet and an air exhaust outlet; a first conduit directing airflow passing through the heat exchanger into the air intake inlet of the airflow generation device; and a second conduit directing airflow from the air exhaust outlet of the airflow generation device through the heater to produce heated air output.

In some embodiments, the at least one heat exchanger comprises a radiator.

In some embodiments, the radiator comprises a fin tube heat exchanger.

In some embodiments, the airflow generation device comprises a fan.

In some embodiments, the fan is a centrifugal fan, and airflow into the air intake inlet is in a first direction and airflow out from the air exhaust outlet is in a second direction substantially transverse to the first direction.

In some embodiments, the centrifugal fan comprises an impellor that rotates about an impellor axis, the first direction is a substantially axial direction relative to the impellor, and the second direction is a substantially transverse direction relative to the impellor axis.

In some embodiments, the heater has an airflow inlet spaced from the air exhaust outlet of the centrifugal fan in the substantially transverse direction.

In some embodiments, the airflow inlet of the heater is substantially aligned with the air exhaust outlet of the centrifugal fan.

In some embodiments, the at least one heat exchanger is a radiator positioned such that the air intake inlet of the airflow generation device faces the radiator.

In some embodiments, the centrifugal fan draws air through the at least one heat exchanger and pushes the air through the heater.

In some embodiments, the heater comprises at least one electric heating element powered by the electrical power generator, and the airflow generation device flows air from the air exhaust outlet, via the second conduit, over the at least one electric heating element and out of the airflow outlet of the heater.

In some embodiments, the system further comprises an airflow regulator that regulates airflow in the first conduit.

In some embodiments, the airflow regulator comprises a butterfly valve operable to selectively restrict airflow through the heater.

In some embodiments, the system is mountable to a trailer.

In some embodiments, the system further comprises a turbo charger.

According to another aspect, there is provided a method for generating heat and electrical power, the method comprising: driving a power generator and an airflow generation device by an engine; powering a heater with power from the power generator; drawing, by the airflow generation device, air through at least one heat exchanger that cools engine coolant; and pushing, by the airflow generation device, the air through the heater.

In some embodiments, the airflow generation device comprises a centrifugal fan.

In some embodiments: drawing air through the at least one heat exchanger comprises drawing air through the at least one heat exchanger comprises drawing air into an air intake inlet in a first direction; and pushing air through the heater comprises pushing air through an air exhaust outlet in a second direction toward the heater and substantially transverse to the first direction.

According to another aspect, there is provided a method for making a generator system for generating heat and electrical power, the method comprising: coupling a power generator and an airflow generation device to an engine such that the engine drives the power generator and the airflow generation device; coupling a radiator to an air intake inlet of the airflow generation device such that the airflow generation device draws air through the radiator; coupling a heater to an air exhaust outlet of the airflow generation device such that the airflow generation device pushes the air through the heater; and powering the heater by the power generator.

In some embodiments, the method further comprises coupling at least one lighting element to the power generator.

In some embodiments, the airflow generation device comprises a centrifugal fan.

Other aspects and features of the present disclosure will become apparent, to those ordinarily skilled in the art, upon review of the following description of the specific embodiments of the disclosure.

### BRIEF DESCRIPTION OF THE DRAWINGS

The present disclosure will be better understood having regard to the drawings in which:

FIG. 1 is a functional block diagram of an example generator system for generating electrical power and heat according to some embodiments;

FIG. 2 is a schematic diagram showing of additional detail of an example generator system for generating electrical power and heat according to some embodiments;

FIG. 3 is a side view of an example portable generator system comprising the generator system of FIG. 2 mounted on a trailer;

FIG. 4 is an opposite side view of the portable generator system FIG. 3;

FIG. 5 is a top view of the portable generator system of FIGS. 3 and 4;

FIG. 6 is a flowchart of a method for generating heat and electrical power according to some embodiments; and

FIG. 7 is a flowchart of a method for making a generator system for generating heat and electrical power according to some embodiments.

### DETAILED DESCRIPTION

As noted above, existing heat and electrical power systems typically include multiple airflow generation devices (or sets of devices) for performing different respective airflow functions. Such multiple airflow generation devices may include: at least one radiator fan for blowing air through a radiator to cool engine coolant; and least one heater fan may be included to blow air through the heater powered by the engine. Such designs may increase complexity, power consumption and maintenance.

According to an aspect of the disclosure, a heat and electrical power generation system is provided that may provide improved and/or more efficient air heating.

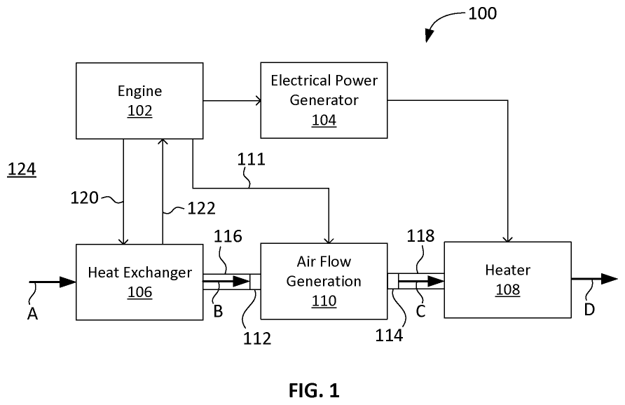

FIG. 1 is a functional block diagram of an example generator system 100 for generating heat and electrical power. The system 100 comprises: an engine 102, an electrical power generator 104 driven by the engine 102; at least one heat exchanger 106 that cools engine coolant; a heater 108 powered by the electrical power generator 104; and an airflow generation device 110 driven by the engine 102 and having an air intake inlet 112 and an air exhaust outlet 114. The generator system 100 further includes: a first airflow conduit 116 directing airflow passing through the heat exchanger 106 into the air intake inlet 112 of the airflow generation device 110; and a second conduit 118 directing airflow from the air exhaust outlet 114 of the airflow generation device 110 through the heater 108 to produce heated air output.

The term “engine” may refer to any device for converting energy from a source to mechanical power. For example, the engine 102 may be a combustion engine that converts fuel to mechanical power. The term “electrical power generator” refers to any device configured to convert mechanical power (from the engine) into electrical power. Embodiments are not limited to any particular engine or electrical power generator. The at least one heat exchanger 106 may typically be a radiator. In this example, the heat exchanger 106 is an air-cooled radiator.

The engine 102 provides mechanical power that drives the electrical power generator 104. In some embodiments, the engine 102 also mechanically drives the airflow generation device 110. The heater 108 is electrically powered by the electrical power generator 104. The heater 108 may be any type of heater suitable for heating airflow, such as one or more coiled heater elements.

The term “airflow generation device” refers to any device capable of moving air to generate airflow. For example, the airflow generation device 110 may be a fan coupled to the engine 102 by a mechanical coupling 111 (e.g., a belt system). The fan may be a centrifugal fan having an impellor that rotates about an impellor axis. The impellor may be a fan wheel. However, embodiments are not limited to particular type of airflow generation device 110 or mechanical coupling between the airflow generation device 110 and the engine 102. The airflow generation device 110 may be electrically driven rather than mechanically driven in other embodiments.

FIG. 1 also shows first and second engine coolant lines 120 and 122, respectively. First engine coolant line 120 carries hot engine coolant from the engine 102 to the heat exchanger 106 to be cooled. Second engine coolant line 122 carries cooled engine coolant from the heat exchanger 106 back to the engine 102. Embodiments are not limited to any particular method or arrangement for carrying coolant between the engine 102 and the heat exchanger 106.

The airflow generation device 110 (e.g., centrifugal fan) draws air through the heat exchanger 106 from the outside environment 124 (as indicated by arrow “A”) and to the air intake inlet 112 via the first conduit 116 (as indicated by arrow “B”). The airflow passing through the heat exchanger 106 cools the engine coolant. In other words, heat from the coolant passes from the coolant to the air passing through the heat exchanger 106, thereby heating the air. The term “conduit” refers to any structure designed to direct fluid flow (air flow in this case) along a path. The first conduit 116 may comprise one or more ducts or other airway structures.

The airflow generation device 110 blows air (entering at the air intake inlet 112) out through the air exhaust outlet 114 via the second air conduit 118 (as indicated by arrow “C”). The airflow, thus, passes through the heater 108 where it is further heated to produce heated air output (indicated by arrow “D”). The second conduit 118 may comprise one or more ducts or other airway structures.

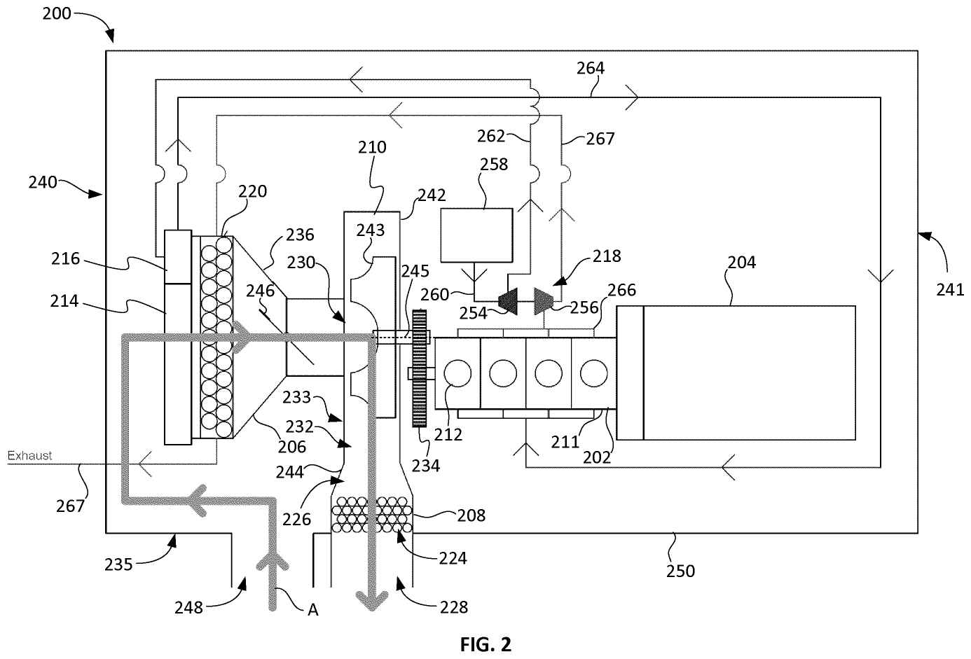

FIG. 2 is a schematic diagram of a generator system 200 for generating heat and electrical power according to some embodiments. The generator system 200 is similar to the system 100 of FIG. 1, but additional detail of the specific example system 200 is shown in FIG. 2. Embodiments are not limited to the specific features shown in FIG. 2.

The generator system 200 comprises an engine 202, an electrical power generator 204, a radiator 206, a heater 208, and an airflow generation device 210.

The engine 202 may typically be a combustion engine. The engine 202 in this embodiment includes an engine block 211 with cylinders 212. The engine 202 may use any suitable fuel combustible fuel type, such as diesel, natural gas, gasoline, jet fuel, kerosene, etc. The engine may, for example, be a diesel combustion engine. It will be understood, however, that the disclosure is not limited to a particular engine or fuel type.

The electrical power generator 204 is driven by the engine 202. Mechanical power from the engine 202 is converted into electrical energy by the electrical power generator 204. For example, the electrical power generator 204 may comprise a turbine (not shown) driven by the engine 202. In some embodiments, a power shaft rotated by the engine 202 is coupled to the electrical power generator 204, and mechanical power is provided to the turbine of the electrical power generator 204 via the power shaft. Any suitable electrical power generation mechanism may be used by the power generator 204 to convert mechanical power from the engine 202 to electrical power.

The radiator 206 cools engine coolant that is flowed through the engine 202 and the radiator 206. Engine coolant is typically a fluid with a relatively high thermal capacity. Heated coolant from the engine is flowed through the radiator 206 (typically through a tube system), which functions as a heat exchanger. Air is also flowed through the radiator and heat is transferred from the coolant to the air. The radiator 206 optionally includes both an engine coolant radiator portion 214 and an intercooler 216. Hot coolant from the engine 202 flows through the engine coolant radiator portion 214 to be cooled by air moving through the engine coolant radiator portion 214. The intercooler 216 comprises an air-to-air heat exchanger that cools air for an optional turbo charger 218 discussed in more detail below. The radiator 206 also includes an exhaust heat exchanger portion 220. In this example, the exhaust heat exchanger portion 220 is a fin tube heat exchanger, although embodiments are not limited to any particular radiator or heat exchanger type.

The heater 208 is powered by the power generator 204. The heater 208 may comprise one or more electrical heating elements, such as resistive heating elements 224 (i.e., a resistive load). The heater 208 has an airflow inlet 226 and an airflow outlet 228. Air that flows into the airflow inlet 226 may then flow over the resistive heating elements 224 to be heated. The heater air exits from the outlet 228 of the heater 208.

The airflow generation device 210 is driven by the engine 202 and includes an air intake inlet 230 and an air exhaust outlet 232. In this embodiment, the airflow generation device 210 is a centrifugal fan having an impellor 243 mounted in a fan housing 242. However, other types of blowers or fans may be used in other embodiments rather than a centrifugal fan. The centrifugal fan 210 in this embodiment is coupled to the engine by a belt assembly 234.

The impellor 243 rotates about a central impellor axis 245. The impellor 243 is a fan wheel in this embodiment. Air flows into the air intake inlet 230 in a first direction, which is substantially aligned with the impellor axis 245. Air flows out from the air exhaust outlet 232 in a second direction, which is substantially transverse to the first direction and the impellor axis 245. The air intake inlet 230 may be referred to as being positioned at a “front” of the centrifugal fan for ease of description. The periphery of the housing 242 about the outer periphery (circumference) of the impellor 243 may be referred to as “sides” of the fan 210 herein. The radiator 206 is positioned “forward” of the air intake inlet 230 in that it is spaced from the air intake inlet 230 along the impellor axis 245 in an upstream, axial direction relative to the fan 210.

The radiator 206 is positioned such that the air intake inlet 230 of the fan 210 faces the radiator 206. The air intake inlet 230 of the centrifugal fan 210 is coupled, via a first conduit 236, to the exhaust heat exchanger portion 220 of the radiator 206. The first conduit 236, thus, directs airflow from the radiator 206 to the air intake inlet 230 of the centrifugal fan 210. In other words, the centrifugal fan 210 draws air through the radiator 206. The airflow through the radiator 206 may, thus, effectively be an “induced flow” that may be relatively evenly distributed across the radiator 206. The radiator 206 is mounted toward a front 240 of the system 200, and the centrifugal fan 210 is mounted behind the radiator 206. The engine 202 is rear of the fan 210, and the power generator is positioned rear of the engine 202 and toward the rear 241 of the system 200. The terms “front” and “rear” are used for illustrative purposes herein and do not limit the system 200 to any particular orientation in use.

The first conduit 236 in this example is in the form of a duct connected from the exhaust heat exchanger portion 220 of the radiator 206 to the air intake inlet 230 of the centrifugal fan 210. The first conduit 236 may have any suitable shape. In this example, the first conduit 236 narrows from the width of the exhaust heat exchanger portion 220 of the radiator 206 to the width of the air intake inlet 230, and the first conduit 236 extends in a substantially straight direction with no turns. However, embodiments are not limited to any particular duct configuration. In some embodiments, the housing 242 of the centrifugal fan 210 may be connected directly to a housing of the radiator 206, with the housings forming the first conduit.

A second conduit 244 is conduit directs airflow from the air exhaust outlet 232 of the centrifugal fan 210 to the airflow inlet 226 of the heater 208. In this example, air flows in an axial direction into the centrifugal fan 210, and the centrifugal fan 210 blows air out in a direction that is transverse to the axial direction. The heater 208 may be spaced from the air exhaust outlet 232 of the centrifugal fan 210 in the substantially transverse direction. The airflow inlet 226 of the heater 208 is substantially aligned with the air exhaust outlet 232 of the centrifugal fan in this example. Specifically, the airflow inlet 226 generally faces the air exhaust outlet 232 such that airflow from the air exhaust outlet is in a direction substantially toward the airflow inlet 226.

Thus, with the fan 210 aligned with air intake inlet 230 facing the front 240 of the system, the heater 208 may be positioned adjacent a side 233 of the fan 210 (with air exiting to a side 235 of the system 200). The airflow from the radiator 206 to the air intake inlet 230 of the fan 210 (via first conduit 236) may be substantially straight. Airflow from the air exhaust outlet 232 of the fan 210 to heater 208 (via second conduit 244) and out of outlet 228 may also be substantially straight. Thus, the fan 210 may draw air through the radiator 206 and push the air through the heater 208 in a relatively efficient manner.

The term “substantially straight” as used herein does not require the airflow path to be precisely or absolutely straight. The airflow path may change in cross-sectional area due to component sizes, etc. The airflow path may also have slight bends (e.g., less than 15 degrees) to accommodate structural requirements. However, sharp turns may be avoided. For example, the first conduit 236 shown in FIG. 2 changes in cross-sectional size between the radiator 206 and air intake inlet 230, but is relatively straight in overall direction. The term “substantially aligned” as used herein also allow for some degree of lateral misalignment in one or more dimensions so long as the airflow path between the two aligned elements is still substantially straight.

In operation, the engine 202 drives the power generator 204 and also drives the centrifugal fan 210. The power generator 204 generates electrical power and at least a portion of that electrical power is used to power the heater 208. The centrifugal fan 210 draws air through the radiator 206 and then blows that air through the heater 208. Thus, a single centrifugal fan 210 moves air through both the radiator 206 and the heater 208 in this embodiment. The transverse direction of the exhaust from the centrifugal fan 210 may allow a short, straight airflow path from the fan 210 to the heater 208 and airflow outlet 228. This arrangement may avoid the need for additional fans or blowers to move air from the radiator to the heater.

The speed (i.e., rpm) of the centrifugal fan 210 may be determined by the speed (rpm) of the engine 202. For example, the engine 202 may typically run at 2800 rpm. However, it may be desirable to change the amount of airflow through the heater 208 while not changing the speed of the engine 202. One or more airflow regulators may be positioned in the path of the airflow to regulate the airflow without needing to change the speed of the fan 210. In the embodiment of FIG. 2, the system 200 includes an airflow regulator operable to selectively restrict airflow through the first conduit 236. In this embodiment, the airflow regulator is a butterfly valve 246 mounted in the first conduit 236 for controlling airflow. The butterfly valve 246 is controllable to selectively move between fully closed and fully opened positions (and variable positions therebetween). The butterfly valve 246 may, thus, control the amount of airflow through the centrifugal fan 210 and the heater 208. If more heated air flowing from the heater is desired, the butterfly valve 246 may be at least partially opened. If less or no heated air flowing from the heater is desired, the butterfly valve 246 may be at least partially closed.

The general airflow path through the system is illustrated by line “A” in FIG. 2. As shown, air is drawn through an air inlet 248 in an outer housing 250 of the system 200 shown in FIG. 2. The housing at least partially encloses the engine 202, the power generator 204, the radiator 206, the heater 208 and the fan 210. The inlet may 248, for example, be in a side of the housing 250. However, it is to be understood that the number, size, shape and position of inlets in the housing may vary. It will also be understood that air drawn through the inlet will not all follow the exact path indicated by line “A” in FIG. 2 before entering the radiator 206.

Some additional airflow may also be provided through the power generator 204. The power generator may, for example, include its own internal fan (not shown) to move air therethrough. One or more openings such as a louvre vent (not shown) may be disposed in the housing 250 proximate the power generator 204 to allow air into the power generator 204. For example, such openings may be positioned at the rear 241 of the housing 250. Air vented through the power generator 204 may then flow in the space between the housing 250 and the components of the system 200 in FIG. 2 and to the radiator 206. This additional airflow from the power generator 204 may, for example, account for approximately 5% of total airflow through the radiator 206.

The system 200 in this example also includes optional turbo charger 218. The turbo charger 218 includes a cold side 254 and a hot side 256. Air is drawn through an engine air filter 258 into the cold side 254 (via air line 260) where the air is compressed, which heats the air. The compressed air travels from the cold side 254 to the intercooler 216 (via compressed air line 262) where it is cooled. The intercooler 216 in this example is an air-to-air heat exchanger. The cooled compressed air travels to the engine block 211 (via compressed air line 264). The exhaust from the engine block 211 travels to the hot side 256 of the turbo charger 218 (via exhaust air lines 266). Hot compressed air exits the hot side 256 and travels to the exhaust heat exchanger portion 220 of the radiator 206 (via exhaust air line 267).

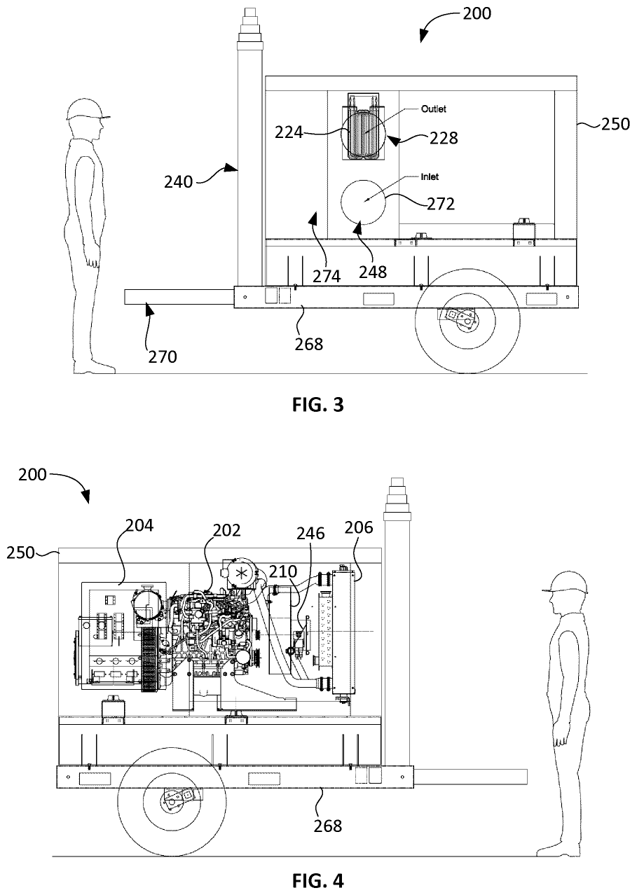

FIG. 3 is a side view of the system 200 of FIG. 2 mounted on a trailer 268 according to an embodiment. As shown, the system 200 is mounted on the trailer 268 with the front 240 toward a hitch end 270 of the trailer 268. The air inlet 248 is in the form of an air inlet opening 272 disposed in a side 274 of the housing 250 to allow air to flow into the interior of the housing 250. The outlet 228 of the heater 208 (shown in FIG. 2) is disposed in the side 274 of the housing 250. In this embodiment, the outlet 228 is located above the air inlet opening 272, but embodiments are not limited to this arrangement. It will be appreciated that the location of the air inlet opening 272 may vary.

Resistive heating elements 224 of the heater 208 are also shown for illustrative purposes (though they would be partially hidden by the side 274 of the housing 250).

FIG. 4 is an opposite side view of the system 200 and trailer 268 with a side of the housing, opposite to the side 274 shown in FIG. 2, removed. The engine 202, the power generator 204, the radiator 206, and the centrifugal fan 210 are visible in FIG. 3.

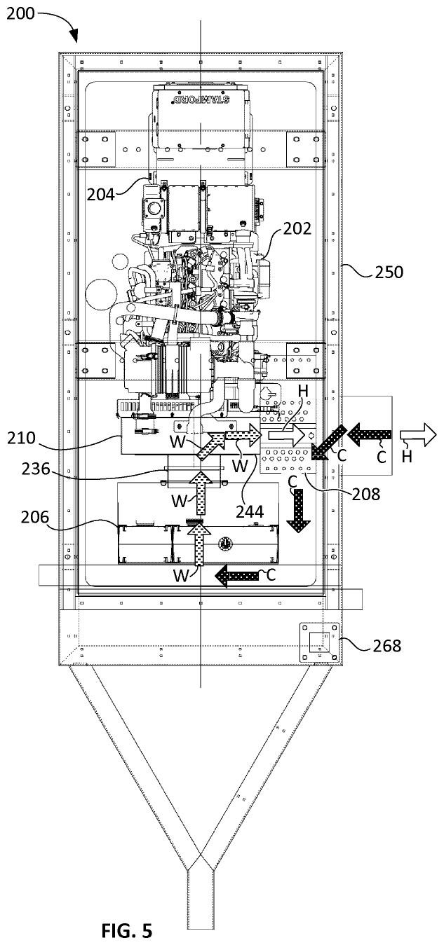

FIG. 5 is a top view of the system 200 and trailer 268 with a top of the housing removed. The engine 202, the power generator 204, the radiator 206, the heater 208 and the centrifugal fan 210 are visible in FIG. 5.

The outer housing 250 is shown as generally box shaped in this embodiment, but the shape may vary in other embodiments. The housing may generally comprise metal, but the material composition may also vary. Embodiments are not limited to any particular housing configuration.

In FIG. 5, arrows labeled “C” represent cool airflow into the system and to the radiator 206, arrows labeled “W” represent warm airflow from the radiator to the heater 208, and arrows labeled “H” represent hot airflow from the heater 208. The terms “cool”, “warm”, and “hot” are used to refer to relative temperatures of the air and do not imply or require any particular absolute temperature.

In some embodiments, the system 200 may further include one or more lighting elements (not shown). A portion of the electrical power generated by the power generator 204 may power the one or more lighting elements. For example, the one or more lighting elements may comprise a light stack.

The system 200 may further include a controller (not shown) for controlling the operating mode of the system 200. The controller may, for example, control the ratio of power used by the heater 208 and the one or more lighting elements. The controller may also control the airflow through the heater (e.g., by controlling the butterfly valve 246 in FIG. 2). The system 200 may also include one or more load banks, and the controller may selectively activate the one or more load banks as needed or desired to address under-loading of the engine 202. For example, the one or more load banks may be used to prevent or reduce wet stacking in the engine 202.

The controller may include user interface elements (e.g., buttons, touchscreen, etc.) to allow a user to provide input to control the system. In some embodiments, the controller may include a processor and a memory storing instructions that, when executed, cause the processor to control the system. The processor and memory may, for example, be in the form of a programmable logic controller (PLC). The controller may have an “auto-load” function that automatically load the engine 202 (e.g., including engaging one or more load banks) if one or more conditions are met. The conditions may, for example, include the engine being run in an idle mode for a predetermined time.

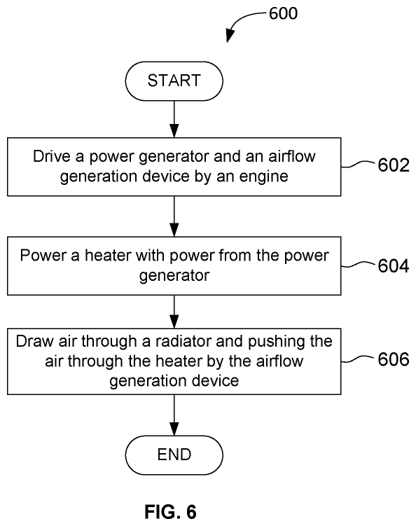

FIG. 6 is a flowchart of a method 600 for generating heat and power according to some embodiments. The method 600 may be performed by the systems 100 and 200 in FIGS. 1 to 5, for example.

At block 602, an engine drives a power generator and an airflow generation device. The engine may be in the form of the engine 102 in FIG. 1 and/or the diesel combustion engine 202 shown in FIGS. 2 to 5. The engine may be any other suitable engine for providing mechanical power.

At block 604, a heater is powered with power from the power generator. The power from the generator will typically be electrical power. The heater may include at least one electrically powered heating element, such as heating coils. The heater may be in the form of the heater 108 or 208 shown in FIGS. 1 to 5, for example. One or more electrical wires, or any other suitable electrical connection means may be used to electrically couple the heater to the power generator. Other equipment, such as at least one transformer or adaptor, may be coupled intermediate the heater and the power generator, and the heater need not be coupled directly to the power generator.

At block 606, air is drawn through a radiator (or other heat exchanger for cooling engine coolant) and pushed through the heater by an airflow generation device. In some embodiments, the airflow generation device is a fan, such as the centrifugal fan 210 shown in FIGS. 2 to 5. Drawing air through the at least one heat exchanger may comprise drawing air through the at least one heat exchanger comprises drawing air into an air intake inlet in a first direction. Pushing air through the heater comprises pushing air through an air exhaust outlet in a second direction toward the heater and substantially transverse to the first direction.

Optionally, the method may further comprise powering at least one lighting element by the power generator. For example, one or more sets of lights for illuminating a work area may be powered by the generator.

The steps shown in blocks 602, 604 and 606 of FIG. 6 and described above may be performed concurrently and are not limited to the particular order shown in FIG. 6.

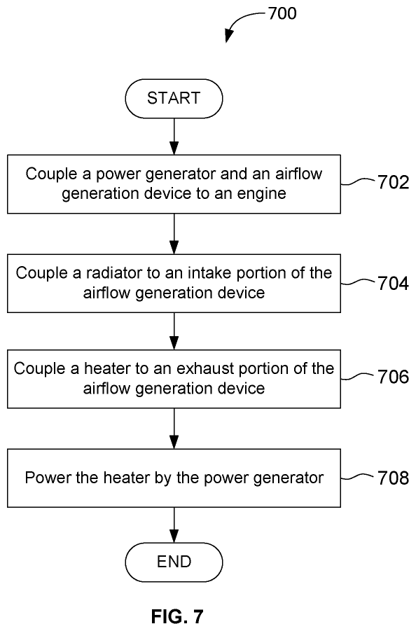

FIG. 7 is a flowchart of a method 700 for making a generator system for generating power and heat, such as the system 100 or 200 shown in FIGS. 1 to 4, according to some embodiments.

At block 702, a power generator (e.g., the electrical power generator 104 or 204 in FIGS. 1 to 5) and an airflow generation device (e.g., the centrifugal fan 210 in FIGS. 2 to 5) are coupled to an engine (e.g., the engine 102 or 202 in FIGS. 1 to 5) such that the engine drives power generator and the airflow generation device.

At block 704, a heat exchanger for cooling engine coolant (e.g., the heat exchanger 106 in FIG. 1 and/or radiator 206 in FIGS. 2 to 5) is coupled to an air intake inlet of the airflow generation device by a first airflow conduit such that the airflow generation device draws air through the radiator. The method may further comprise, positioning the radiator and/or airflow generation device such that the air intake inlet of the airflow generation device faces the heat exchanger.

At block 706, a heater (e.g., the heater 108 or 208 in FIGS. 1 to 5) is coupled to an air exhaust outlet of the airflow generation device such, by a second airflow conduit, that the airflow generation device pushes the air through the heater. The method may further comprise positioning the heater and/or airflow generation device such that an airflow inlet of the heater faces the air exhaust outlet of the airflow generation device.

At block 708, the heater is electrically coupled to the power generator such that is may be powered by the power generator to heat air flowing therethrough.

The method 700 may further comprise electrically coupling at least one lighting element to the power generator.

The method may optionally further comprise providing a housing around at least one: of the engine, the power generator, the heat exchanger, the airflow generation device and the heater. The housing may have at least one first opening to allow air in the surrounding environment to flow into the housing to be drawn through the heat exchanger. The housing may have at least one second opening for air from the heater to flow out of the housing into the surrounding environment. The housing may be similar to the housing 250 shown in FIGS. 3 to 5, for example, although embodiments are not limited to any particular housing.

The steps shown in blocks 702, 704, 706 and 708 of FIG. 7 and described above may be performed in another order and/or one or more steps may be performed concurrently. The method is not limited to the particular order shown in FIG. 7.

It is to be understood that a combination of more than one of the features of different embodiments described above may be implemented. Embodiments are not limited to any particular one or more of the features, methods or apparatuses disclosed herein. One skilled in the art will appreciate that variations or alterations of the embodiments described herein may be made in various implementations without departing from the scope of the claims.

1. A generator system for generating heat and electrical power, the system comprising:
an engine;
an electrical power generator driven by the engine;
at least one heat exchanger that cools engine coolant;
a heater powered by the electrical power generator;
a fan driven by the engine and having an air intake inlet and an air exhaust outlet, the fan drawing air in a first direction through the air intake and blowing the air in a second direction out of the exhaust outlet;
a first conduit directing airflow passing through the at least one heat exchanger into the air intake inlet of the fan; and
a second conduit directing airflow from the air exhaust outlet of the fan in the second direction and through the heater to produce heated air output,
wherein the heater is positioned and spaced in the second direction from the air exhaust outlet of the fan, and an airflow inlet of the heater is substantially aligned with the air exhaust outlet.

2. The generator system of claim 1, wherein the at least one heat exchanger comprises a radiator.

3. The generator system of claim 2, wherein the radiator comprises a fin tube heat exchanger.

4. The generator system of claim 1 wherein the second conduit is substantially straight.

5. The generator system of claim 1, wherein the fan is a centrifugal fan, and the second direction is substantially transverse to the first direction.

6. The generator system of claim 5, wherein the centrifugal fan comprises an impellor that rotates about an impellor axis, the first direction is a substantially axial direction relative to the impellor, and the second direction is a substantially transverse direction relative to the impellor axis.

7. The generator system of claim 1, wherein the at least one heat exchanger is positioned forward of the fan.

8. The generator system of claim 7, wherein the heater is positioned to a side of the fan in the second direction.

9. The generator system of claim 5, wherein the at least one heat exchanger is a radiator positioned such that the air intake inlet of the fan faces the radiator.

10. The generator system of claim 5, wherein the centrifugal fan draws air through the at least one heat exchanger and pushes the air through the heater.

11. The generator system of claim 1, wherein the heater comprises at least one electric heating element powered by the electrical power generator, and the fan flows air from the air exhaust outlet, via the second conduit, over the at least one electric heating element and out of the exhaust outlet of the heater.

12. The generator system of claim 1, further comprising an airflow regulator that regulates airflow in the first conduit.

13. The generator system of claim 12, wherein the airflow regulator comprises a butterfly valve operable to selectively restrict airflow through the heater.

14. The generator system of claim 1, wherein the system is mountable to a trailer.

15. The generator system of claim 1, further comprising a turbo charger.

16. A method for generating heat and electrical power, the method comprising:
driving a power generator and a fan by an engine;
powering a heater with power from the power generator;
drawing, by the fan, air in a first direction through at least one heat exchanger that cools engine coolant; and
pushing, by the fan and in a second direction substantially transverse to the first direction, the air from an air exhaust outlet of the fan through an airflow inlet of the heater, wherein the heater is positioned and spaced in the second direction from the air exhaust outlet of the fan, and the airflow inlet of the heater is substantially aligned with the air exhaust outlet.

17. The method of claim 16, wherein the fan comprises a centrifugal fan.

18. The method of claim 16, wherein: drawing air through the at least one heat exchanger comprises drawing air through a second conduit and into an air intake inlet in a first direction; and pushing air through the heater comprises pushing air through the air exhaust outlet and a second conduit in the second direction toward the heater.

19. A method for making a generator system for generating heat and electrical power, the method comprising:
coupling a power generator and a fan to an engine such that the engine drives the power generator and the fan;
coupling a radiator to an air intake inlet of an airflow generation device such that the fan draws air through the radiator through an air intake inlet of the fan in a first direction, and pushes the air from an air exhaust outlet of the fan in a second direction substantially transverse to the first direction;
coupling a heater to an air exhaust outlet of the fan such that the fan pushes the air the second direction through the heater, wherein the heater is positioned and spaced in the second direction from the air exhaust outlet of the fan, and the air intake inlet of the heater is substantially aligned with the air exhaust outlet; and
powering the heater by the power generator.

20. The method of claim 19, further comprising coupling at least one lighting element to the power generator.

21. The method of claim 19, wherein the fan comprises a centrifugal fan.
